(19) United States
(12) Patent Application Publication
(10) Pub. No.: US 2010/0078121 A1
(43) Pub. Date: Apr. 1, 2010

(54) MULTI-COLOR PRINTING MACHINE WITH FILM-TRANSFER DEVICE

(75) Inventors: Jurgen Scholzig, Mainz (DE); Uwe Puschel, Heidesheim (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Man Roland Druckmaschinen AG, Offenbach (DE)

(21) Appl. No.: 12/516,326

(22) PCT Filed: Dec. 4, 2007
(86) PCT No.: PCT/EP07/10507

§ 371 Date: Sep. 2, 2009

(30) Foreign Application Priority Data
Dec. 23, 2006 (DE) 10-2006-061-442.9

(51) Int. Cl. B32B 38/14; B32B 38/00; B32B 43/00

(52) U.S. Cl. 156/230; 156/387; 156/390

(57) ABSTRACT

In a method for transferring layers from a carrier foil onto printed sheets, an imaging or covering layer is to be transferred from the carrier foil onto the printed sheet in an adhering manner in a sheet processing machine. A more flexible production method is provided in a sheet offset printing machine. To this end, each printed sheet is provided on at least one printed or unprinted first side with a foil coating. Each printed sheet is further turned before or after the coating in the sheet processing machine, and at least printed or coated on the side opposite of the foil coating, and provided with a film coating in a further coating device (2).

### CROSS-REFERENCE TO RELATED APPLICATIONS

This patent application is the national phase of PCT/EP2007/010507, filed Dec. 4, 2007, which claims the benefit of German Patent Application No. 102006061442.9, filed Dec. 23, 2006.

### FIELD OF THE INVENTION

The present invention relates generally to a method and to a device for transferring imaging or cover layers of a carrier film to sheets.

### BACKGROUND OF THE INVENTION

It is known to produce metallic layers on sheets by means of a film-transfer method. For example, a printing material and a printing device that uses this material are described in EP 0 569 520 B1. In a sheet-processing machine with a feeder and a delivery unit, there are printing units and a coating unit. In at least one printing unit, an adhesive pattern is deposited as the print motif in a planographic printing method. An impression cylinder, a press roller, and a film guide are provided in the coating unit following the printing unit. In the film guide, a film strip is guided from a film supply roll through the transfer gap of the coating unit between the compression cylinder and the press roller and wound up again on the outlet side after leaving the coating unit. The transfer film contains a carrier film on which functional layers of different kinds, such as metallic layers made from, for example, aluminum, or plastic layers could be deposited. A separation layer by means of which the functional layer could be stripped from the carrier layer is provided between the functional layer and the carrier film.

After a sheet is provided with an adhesive deposition or an adhesive pattern over an area, it is guided through the coating unit, wherein the sheet lying on the compression cylinder is brought into contact with the film material by means of the press roller. In this way, the functional layer lying on the bottom enters into a tight connection with the regions on the sheet provided with adhesive. Accordingly, the functional layer adheres only in the region of the pattern provided with adhesive or also over the full surface area, wherein the functional layer is removed from the carrier film in the region of the adhesive pattern. The sheet is delivered in the coated state.

Disadvantages of these procedures include that they cannot be applied flexibly, require extensive know-how due to complex processes and are difficult to manage.

### OBJECTS AND SUMMARY OF THE INVENTION

Therefore, an object of the invention is to provide a method and a device by means of which a flexible coating of sheets can be accomplished easily, reliably, economically, and precisely, with the method and device also being easy to manage.

Advantageously, a method is proposed for whose application a sheet-fed rotary printing press is used for a coating or a multiple coating method of one or both sides of sheets to be printed, and the coating is performed in a cold film embossing method.

In this way, one-sided or two-sided film application is advantageously enabled through the combination of coating units, such as, e.g., varnish modules, a device for turning sheets, and also coating modules.

As procedures, the following are provided:

1. One-sided or two-sided coating of a printed material through a film application by a cold film transfer method is used for the production of arbitrary printed products.

2. In inline printing or coating, the processing of film, paper with vapor-coated aluminum lamination or aluminum-coated papers or the application of another film layer can be provided by a sheet-fed rotary printing press and a cold film embossing application for the production of composite packages with one or more coating modules within a printing press.

3. In the combination of processing steps for inline printing, inline varnishing, and inline coating, within a single sheet-fed rotary printing press with varnish modules and one or more cold film embossing devices, the production of printed products is possible with the processing of film or paper of different qualities. The application of another film layer after a pre-coating is also possible. In this way, product properties, a visual or tactile pre-coating, and the application of a decorative film could be combined with each other.

4. In the cold film embossing application, optionally through the combination of printing, sheet turning, film application on the opposite side, optional printing and varnishing, an integration of the cold film embossing method could be suitable for general use for two-sided printing or coating.

5. The processing of aluminum-laminated printed material is another possible solution, wherein a cold film embossing application could be made possible in a sheet-fed rotary printing press or flexographic printing press.

6. The device of the invention contains a coating module for the cold film transfer method before and/or after a turn-over device within a sheet-fed printing press and expands the described processing technology in an advantageous way.

In a face and reverse printing mechanism that has additional mechanisms for varnishing, stamping, embossing, or other types of post-processing, various processes could thus be performed:

A) Face printing, i.e., one-sided printing or coating with subsequent film application, following this one or more color prints, a varnish coating, and inline post-processing through stamping, embossing, creasing, perforation, or the like.

B) Face and reverse printing, i.e., two-sided printing or coating with subsequent film application, thereafter, one or more color printings, a varnish coating, and finally additional inline post-processing through stamping, embossing, creasing, perforation, or the like, or also a pure printing operation without film application.

C) Face printing, i.e., one-sided printing or coating with subsequent film application.

D) Face printing without film application.

E) Use of the cold film transfer module with an appropriately shaped letterpress printing form for simultaneous execution of a post-processing procedure, such as stamping, embossing, or the like.

F) Arrangement of the turn-over device for the face and reverse printing at an arbitrary position in the printing press.

G) Arrangement of a numbering unit in connection with the film transfer module.

Below, the invention will be described in greater detail with reference to illustrative drawings.

Other objects and advantages of the invention will become apparent upon reading the following detailed description and upon reference to the drawings, in which:

### BRIEF DESCRIPTION OF THE DRAWINGS

FIG. 1 is a schematic side view of a sheet-fed rotary printing press with a film transfer module.

FIGS. 2-5 are schematic side views of various configurations of a sheet-fed printing press with a film transfer module.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

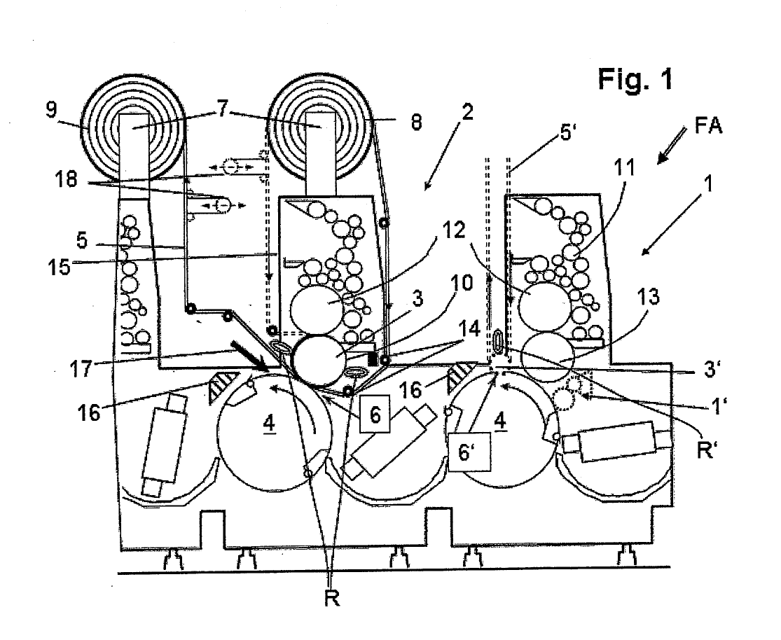

A sheet-processing unit, in this case a printing press, is shown in FIG. 1 that is made from at least two printing units. A sheet to be coated is provided in a first step in the applicator unit 1 with an imaging adhesive pattern. For this purpose, a printing unit of an offset printing press can be used with inking and dampening units 11, a printing plate on one plate cylinder 12, a blanket or rubber cylinder 13, and a compression cylinder 4. Applicator units in the form of flexographic or varnishing units also can be used. The adhesive could also be applied in two applicator units 1, in order to improve its effect on different substrates.

In the second step, a transfer film 5 is guided under pressure with the sheet through a transfer gap 6. A film transfer module 2 used for this purpose could be a printing unit, a varnishing module, a base unit, or another type of processing station of a sheet-fed offset printing press. The transfer gap 6 in the film transfer module 2 is formed by a transfer cylinder 3 and a compression cylinder 4. The transfer cylinder 3 can correspond to a blanket or form cylinder of a known offset printing unit or a varnishing module of a sheet-fed offset printing press. A web guide for transfer films 5 is shown within the film transfer module 2.

A film supply roll 8 is associated with the film transfer module 2 on the side of the sheet guide. The film supply roll 8 has a rotary drive 7. The rotary drive 7 is required for the continuously regulated supply of the transfer film 5 to the film transfer module 2 and is therefore controllable. Furthermore, in the area of the film feed and discharge there are control devices 14, such as deflection or tensioning rollers, pneumatically-powered guide mechanisms, guide plates, or the like. Thus, the film web of the transfer film 5 can always be guided flat without puckering and can be held at the same tension relative to the transfer cylinder 3.

In this way, the transfer film 5 can be guided around the transfer cylinder 3, wherein the transfer film 5 can be fed and discharged in an advantageous way from only one side of the film transfer module 2 outward to the press gap 6 (see dashed lines in diagram). In another embodiment, the transfer film 5 can also be fed to the press gap 6 and discharged essentially tangentially past the transfer cylinder 3, or this film can be looped around this cylinder covering only a small peripheral angle. For this purpose, the transfer film 5 is fed from one side of the film transfer module 2 and discharged to the opposite side of the film transfer module 2. On the outlet side of the printing unit, a film collection roll 9 is shown with which used film material is wound up. Here also, a rotary drive 7 is provided that is controllable.

Dryers 16 are also provided in the area of the adhesive deposition and the film transfer. Thus, e.g., by means of UV drying, the adhesive layer can be pre-dried by a first dryer 16 (intermediate dryer I), so that the useful layer of the transfer film 5 adheres better. Furthermore, the adhesive effect of the embossed useful layer on the sheet can be improved by a second dryer 16 (intermediate dryer II), in that the final drying of the adhesive is also accelerated.

For the transfer process of the imaging, e.g., useful or functional layer from the transfer film 5 to the sheet, the surface of the transfer cylinder 3 is provided with compressible, cushioning elements as the press tensioning device 10 in the transfer gap 6 between the transfer cylinder 3 and the compression cylinder 4.

As shown in FIG. 1, the cold film application could also be constructed in an integrated film transfer module FA. Here, film feeding is also integrated into the same printing unit, in this case the applicator unit 1, so that the adhesive application and film transfer take place in two successive processing gaps on the same compression cylinder 4. For this purpose, an additional applicator unit 1′ can be arranged before the rubber cylinder 13 on the first compression cylinder 4. Then the rubber cylinder 13 acts as a press roller, and the film web 5′ is guided from this through the transfer gap.

Alternatively, an additional press roller 3′ could be arranged after the rubber cylinder 13 on the compression cylinder 4. Then the rubber cylinder 13 applies the adhesive as usual, and an additional transfer gap 6′ is formed by the press roller 3′. The transfer film 5′ is guided through this transfer gap and against the printing substrate for transferring the film coating. Here, a cleaning device R′ could also be arranged, in order to eliminate contamination (glitter) of the transfer film 5′.

With the described device, it is already possible to coat a printed material on one side according to a pattern or to seal it over the entire surface. For this purpose, the device for the film transfer is arranged in a printing or varnishing unit arranged after the printing units of a sheet-fed printing press. Furthermore, in such an arrangement the surface of the fresh print can be protected. For other applications, a second such device could also be arranged downstream of the first device for film transfer within the sheet-fed rotary printing press, so that a double lamination of a sheet is also possible.

A configuration could also be provided that provides a first film transfer module before the first printing unit transferring an ink or a coating and a second film transfer module after the last printing unit transferring ink. Thus, a first coating could be applied directly onto the printed material and a second coating could be applied over the applied printed image.

Using a previously described device for performing the cold film embossing method, procedures could also be performed which if used make possible the coating method or also multiple coating methods for one-sided or two-sided printed products to be coated within a sheet-fed rotary printing press. In this way, advantageously through the combination of coating units, such as, e.g., varnishing modules, a device for turning sheets, as well as coating modules, a one-sided or two-sided film application is enabled. Through the method and devices according to the invention, the production of decorative and functional application could also be enabled in connection with two-sided printability of the printed material.

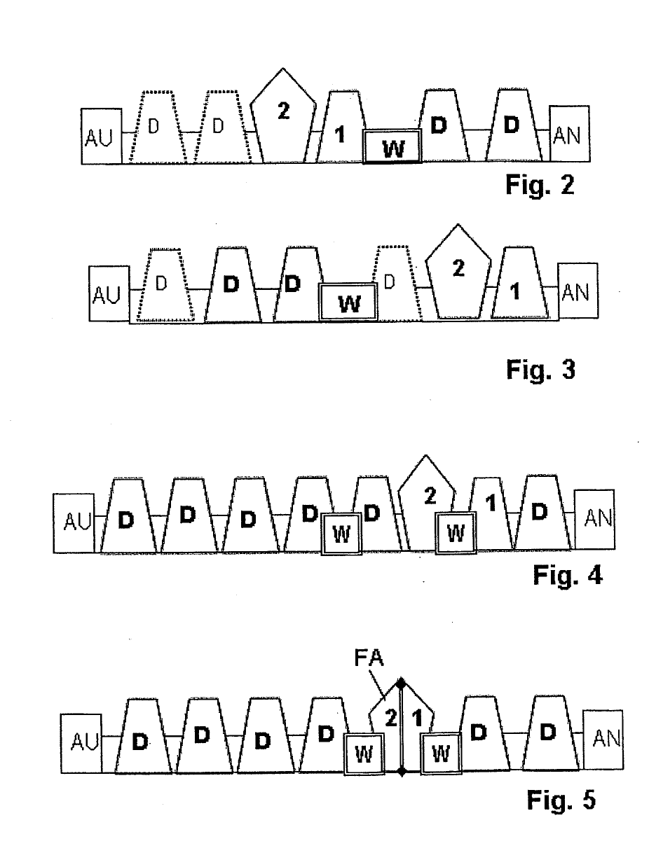

In FIGS. 2 and 3, machine configurations for this purpose are shown schematically that allow, for example, corresponding operating procedures. In FIGS. 2 and 3, printing units D are provided for processing viscous printing inks. Instead of the printing units D, selective varnishing modules for processing liquid varnishes or coating media could also be used. Printing units D could also be used for applying a coating made from liquid coating media.

In FIG. 2, a first variant of such a configuration is shown. After two printing units D or varnishing modules connecting to the sheet feeder AN or a combination of printing units D and varnishing modules, the illustrated printing press has a so-called turn-over device W. Turn-over devices W are used to upend a sheet that has been printed or coated on one side while running through a sheet-fed printing press, so that its previous bottom side becomes the top side that can then be printed or coated. In the illustrated configuration, an applicator unit 1 and a coating module 2, which could also be arranged as an integrated film transfer module FA within a printing unit, attach to the turn-over device W. Then optionally several additional printing units D are provided up to the belt delivery unit AU. With such a printing press, each sheet could be first printed or printed and coated with one or two colors on its reverse side, then coated with a laminating or imaged film layer, and then printed again with multiple colors.

In FIG. 3, a second variant of such a configuration is shown. The illustrated printing press is equipped with a one-part or two-part film transfer module 1, 2 connecting to the sheet feeder AN. One or more printing units D connect to this film transfer module and a so-called turn-over device W connects to these printing units. This turn-over device is used to upend a sheet coated with film material on one side, so that its previous bottom side can then be printed or coated. In the illustrated configuration, several other printing units D can optionally be provided after the turn-over device W up to the sheet delivery unit AU.

In FIGS. 4 and 5, configurations of sheet-fed rotary printing presses with eight printing units D, 1, 2 and two turn-over devices W are shown. In this case, two printing units D, 1, 2 are then provided connecting to the sheet feeder AN, a turn-over device W then follows, another two printing units D, 1, 2 then follow and then 4 printing units D connect up to the sheet delivery unit AU. In principle, the two first printing units could be used for the cold film transfer, so that, in the first turn-over device W after the second printing unit D, the sheet is upended and then printed in six colors on the reverse side or printed in multiple colors, and can be post-processed in some other way.

In FIG. 4 the second printing unit is constructed as an applicator unit 1 and the third printing unit is constructed as a coating module 2. In this case, in the first printing unit D which could also be constructed as a varnishing module, a pre-coating, a first image printing process, or also an embossing, or similar post-processing could be performed. After the cold film transfer by the applicator unit 1 and coating module 2, another coating, covering, or processing could be provided so that after turning in the second turn-over device W, the sheet could then still be printed in four colors on its reverse side.

In FIG. 5, the third printing unit is constructed as an applicator unit 1 and the fourth printing unit is constructed as a coating module 2. These are here shown as an integrated cold film transfer module FA. Here, in the first two printing units D that could optionally also be formed as varnishing modules, a pre-coating, a first two-color image printing process, or also in combination an embossing or similar post-processing could be carried out. After the cold film transfer by the applicator unit 1 and coating module 2, the sheet could be turned in the second turn-over device W, whereupon the sheet could then still be printed with four colors on its reverse side or printed with multiple colors and coated or processed in some other way. With such a printing press, each sheet could be first printed in one or two colors on its reverse side, then turned, then coated with a laminating layer and subsequently printed with multiple colors again.

Furthermore, additional production options are produced in such presses, in that sheets can be provided with optical or tactile patterns that are placed below the film coating and are visible or feelable through these patterns, or also in that visual or tactile surface patterns are deposited by the film itself These coating processes could be performed on non-printed or printed surfaces, in turn, on one side or two sides.

For improving the operation, at least the compression cylinder 4 that is arranged in a printing unit D arranged after a turn-over device W can be provided with a special reverse surface. Here, the already coated side of the sheet encounters the cylinder surface, producing so-called smearing effects. To counteract this effect, the surface of the compression cylinder 4 could be provided with a finish coating, so that absorption of coating materials from the sheet is prevented. Here, the coating could also feature structuring. Likewise, finish coating and structuring could be combined. As an alternative to the direct arrangement on the surface of the compression cylinder 4, a so-called reverse printing plate could also be provided that carries the finish coating and/or structured coating. The reverse printing plate is then arranged detachably on the compression cylinder 4. Naturally, several or all of the compression cylinders 4 in the printing units D that are arranged after a turn-over device W could be provided with such a coating or reverse printing plate.

In this way, a two-sided film application in the inline and/or offline mode should also be possible in order to improve the properties of the printed products, wherein a cold film embossing application in a sheet-fed rotary or flexographic printing press could be possible.

The device includes the coating module for the cold film transfer method before and/or after a turn-over device within a sheet-fed printing press, and expands the described processing technology in advantageous ways.

### LIST OF REFERENCE SYMBOLS

1 Applicator unit
2 Coating unit
3 Press roller
4 Compression cylinder
5 Transfer film/film web
6 Transfer gap
7 Roller drive
8 Film supply roll
9 Film collection roll
10 Press tensioning
11 Inking/dampening unit
12 Plate cylinder
13 Rubber cylinder
14 Control device
15 Printing unit protection
16 Dryer
17 Inspection device
18 Dancer roller
1′ Applicator unit
3′ Press roller
5′ Transfer film/film web
6′ Transfer gap
R′ Cleaning device
D Printing unit
AN Feeder
AU Delivery unit
FA Film transfer module
W Turn-over device

1-20. (canceled)

21. A method for transferring functional layers from a carrier film to sheets in a sheet-processing machine including an applicator unit for coating each sheet with an adhesive and a coating unit for transferring functional layers from the carrier film to the sheet, a transfer gap being formed in the coating unit, the carrier film being arrangeable along the surface of a press roller with a coated side of the carrier film contacting the sheet and being guidable under pressure together with the sheet through the transfer gap so that the functional layers are transferred from the carrier film to the sheet in areas provided with the adhesive, the method comprising the steps of:
providing each sheet with a film coating from the carrier film on a first side of the sheet in the transfer gap;
turning each sheet over in the sheet-processing machine; and
printing or film coating each sheet on a second side of the sheet opposite the first side.

22. The method according to claim 21, wherein each sheet is first at least printed on the second side, then turned over in the sheet-processing machine and the film coating is then provided on the first side of the sheet.

23. The method according to claim 21, wherein each sheet is first provided on the first side with the film coating from the carrier film, then turned over in the sheet-processing machine, and the sheet is then at least printed on the second side.

24. The method according to claim 21, wherein each sheet is first provided on the first side with the film coating from the carrier film, then turned over in the sheet-processing machine, and the sheet is then coated with another film coating on the second side.

25. The method according to claim 24, wherein the first and second sides of each sheet are pre-coated and each sheet is first provided on the pre-coated first side with the film coating from the carrier film, then turned over and the second pre-coated side of the sheet is then coated with another film coating.

26. The method according to claim 21, wherein each sheet is first provided on the first side with the film coating from the carrier film on which a print image is applied, then turned over in the sheet-processing machine, and the sheet is then coated with another film coating on the second side on which a print image is applied.

27. The method according to claim 26, wherein the first and second sides of each sheet are pre-coated and each sheet is first provided on the pre-coated first side with the film coating from the carrier film, then turned over and the second pre-coated side of the sheet is then coated with another film coating.

28. The method according to claim 21, further including the step of providing the first side of each sheet with a pre-coating.

29. The method according to claim 28, wherein the pre-coating is performed using inkjet printing heads.

30. The method according to claim 28, wherein the pre-coating is performed in a coating unit by at least printing method from the group consisting of letterpress printing, intaglio printing, or planographic printing.

31. The method according to claim 21, further including the step of providing the first side of each sheet with a pre-coating from a carrier film in a transfer gap, wherein the pre-coating is transferred in the transfer gap from the carrier film onto the sheet together with an imaging layer.

32. A device for transferring functional layers from a transfer film onto sheets comprising in a sheet-processing machine:
a sheet feeder;
a sheet delivery unit;
a film transfer module including an applicator unit for coating each sheet with an adhesive over an area and a coating unit for transferring functional layers from the carrier film to the sheet, a transfer gap being formed in the coating unit, the carrier film being arrangeable along the surface of a press roller with a coated side of the carrier film contacting the sheet and being guidable under pressure together with the sheet through the transfer gap so that the functional layers are transferred from the carrier film to the sheet in areas provided with the adhesive;
a plurality of processing units arranged between the sheet feeder and the sheet delivery unit; and
a sheet turning device arranged between two of the processing units for turning the sheets over so that after the printing and/or coating of a first side of the sheet in processing units upstream of the sheet turning device a printing and/or coating is applicable in processing units downstream of the sheet turning device on a second side of the sheet;
wherein the film transfer module is one of the plurality of processing units.

33. The device according to claim 32, wherein one of processing units is a varnishing module or printing unit and the processing units further include one or more printing units and wherein the plurality of processing units are arranged as follows between the sheet feeder and the sheet delivery unit in a sheet-transport direction:
the film transfer module;
the sheet turning device;
the varnishing module or printing unit; and
the one or more printing units.

34. The device according to claim 32, wherein one of processing units is a varnishing module or printing unit and the processing units further include one or more printing units and wherein the plurality of processing units are arranged as follows between the sheet feeder and the sheet delivery unit in a sheet-transport direction:
the varnishing module or printing unit;
the film transfer module;
the sheet turning device; and
the one or more printing units.

35. The device according to claim 32, wherein the processing include a plurality of printing units and wherein the plurality of processing units are arranged as follows between the sheet feeder and the sheet delivery unit in a sheet-transport direction:
one or more of the plurality of printing units;
the film transfer module;
the sheet turning device;
one or more of the plurality of printing units; and
the film transfer module.

36. The device according to claim 32, further including a second film transfer module and wherein the processing units include first and second varnishing modules or printing units and the processing units further include a plurality of printing units and wherein the plurality of processing units are arranged as follows between the sheet feeder and the sheet delivery unit in a sheet-transport direction:
the first varnishing module or printing unit;
the film transfer module;
one or more of the plurality of printing units;
the sheet turning device;
the second varnishing module or printing unit;
the second film transfer module; and
one or more of the plurality of printing units.

37. The device according to claim 32, wherein the processing units include a plurality of printing units and wherein the plurality of processing units are arranged as follows between the sheet feeder and the sheet delivery unit in a sheet-transport direction:
the film transfer module;
one or more of the plurality of printing units;
the sheet turning device; and
one or more of the plurality of printing units.

38. The device according to claim 32, further including a second film transfer module and wherein one of processing units is a varnishing module or printing unit and the processing units further include one or more printing units and wherein the plurality of processing units are arranged as follows between the sheet feeder and the sheet delivery unit in a sheet-transport direction:
the varnishing module or printing unit;
the film transfer module;
the sheet turning device;
the one or more printing units; and
the second film transfer module.

39. The device according to claim 32, further including second and third film transfer modules and wherein one of processing units is a varnishing module or printing unit and the processing units further include one or more printing units and wherein the plurality of processing units are arranged as follows between the sheet feeder and the sheet delivery unit in a sheet-transport direction:
the varnishing module or printing unit;
the film transfer module;
the sheet-turning device;
the second film transfer module;
the one or more printing units; and
the third film transfer module.

40. The device according to claim 32, wherein the processing units include printing units arranged downstream of the sheet turning device having a printing cylinder with a a finish-coated or structured surface.
